(19) United States
(12) Patent Application Publication
(10) Pub. No.: US 2014/0139187 A1
(43) Pub. Date: May 22, 2014

(54) POWER SUPPLY CIRCUIT

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: XI-RONG PENG, Shenzhen (CN); SONG-LIN TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,261

(22) Filed: Dec. 24, 2012

(30) Foreign Application Priority Data
Nov. 19, 2012 (CN) 2012104677214

(51) Int. Cl. H02J 7/00

(52) U.S. Cl. CPC H02J 7/007
USPC 320/134

(57) ABSTRACT

A power supply circuit includes a load, a chargeable battery, a discharging circuit, a charging circuit, an adapter, and a control circuit. When the adapter operates normally, the control circuit measures a voltage of the chargeable battery, and controls the charging circuit to charge the chargeable battery when the voltage of the chargeable battery is less than a preset value. The control circuit measures a charging current and a temperature of the chargeable battery, and regulates the charging current through the charging circuit according to the measured charging current and temperature. The adapter provides a voltage to the load through the discharging circuit. When the adapter is powered off, the control circuit does not sense a voltage a voltage from the adapter. The control circuit controls the chargeable battery to power the load through the discharging circuit.

### BACKGROUND

1. Technical Field

The present disclosure relates to a power supply circuit.

2. Description of Related Art

At present, storage devices are widely used in computer for storing data. However, when the computer is powered off abnormally, the storage device may not be able to store volatile data because of the sudden loss of power. Therefore, there is room for improvement in the art.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a block diagram of a power supply circuit in accordance with an exemplary embodiment of the present disclosure, the power supply circuit includes a charging circuit, a control circuit, and a discharging circuit.

FIG. 2 is a circuit diagram of the charging circuit of FIG. 1.

FIG. 3 is a circuit diagram of the control circuit of FIG. 1.

FIG. 4 is a circuit diagram of the discharging circuit of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

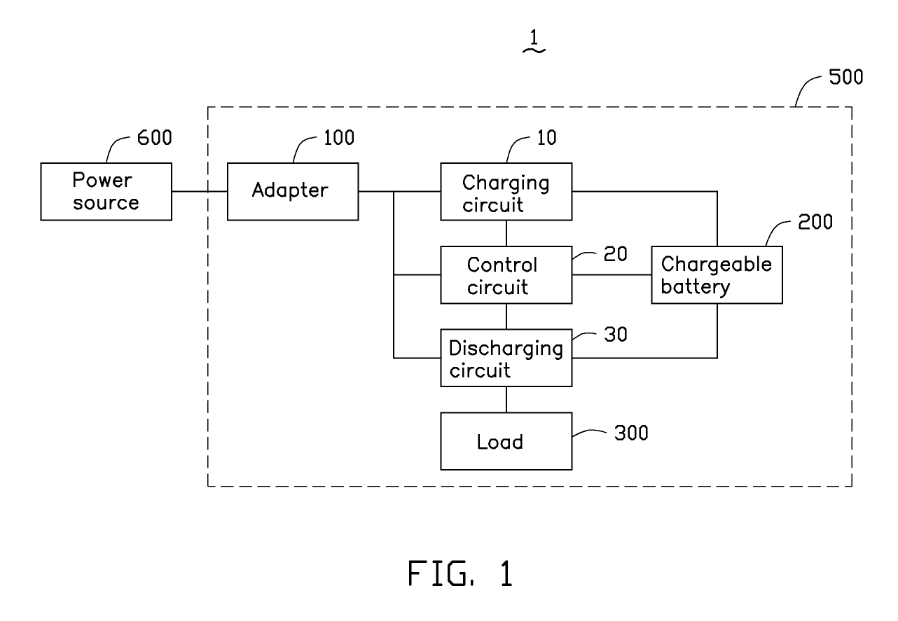

FIG. 1 shows a power supply circuit 500 arranged in a storage device 1 in accordance with an embodiment. The power supply circuit 500 includes an adapter 100, a charging circuit 10, a control circuit 20, a discharging circuit 30, a chargeable battery 200, and a load 300. The adapter 100 is connected to a power source 600 for converting a voltage received from the power source 600 and providing the converted voltage to the storage device 1. When the adapter 100 operates normally, the control circuit 20 measures a voltage of the chargeable battery 200, and controls the charging circuit 10 to charge the chargeable battery 200 when the voltage of the chargeable battery 200 is less than a preset value. The control circuit 20 measures a charging current and a temperature of the chargeable battery 200 and regulates the charging current through the charging circuit 10. The adapter 100 provides a voltage to the load 300 through the discharging circuit 30. When the adapter 100 is powered off, the control circuit 20 does not measure the voltage of the adapter 100, and controls the chargeable battery 200 to discharge through the discharging circuit 30, to provide the voltage to the load 300.

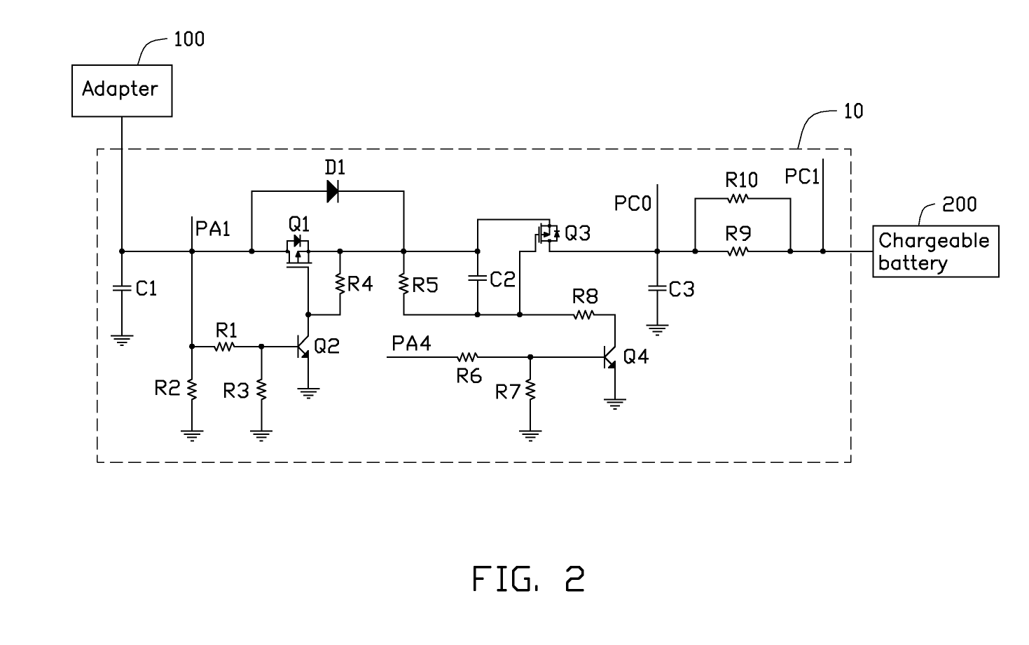

Referring to FIG. 2, the charging circuit 10 includes resistors R1-R10, capacitors C1-C3, transistors Q2 and Q4, field effect transistors (FETs) Q1 and Q3, and a diode D1. The adapter 100 is connected to a drain of the FET Q1 and also grounded through the capacitor C1. The drain of the FET Q1 is also connected to an anode of the diode D1 and the control circuit 20, and grounded through the resistor R2. A gate of the FET Q1 is connected to a collector of the transistor Q2. An emitter of the transistor Q2 is grounded. A base of the transistor Q2 is grounded through the resistor R3 and also connected to the drain of the FET Q1 through the resistor R1. The resistor R4 is connected between a source of the FET Q1 and the gate of the FET Q1. A cathode of the diode D1 is connected to the source of the FET Q1. A gate of the FET Q3 is connected to a collector of the transistor Q4 through the resistor R8 and also connected to the source of the FET Q1 through the resistor R5. The source of the FET Q1 is connected to the source of the FET Q3, and connected to the gate of the FET Q3 through the capacitor C2. An emitter of the transistor Q4 is grounded. A base of the transistor Q4 is grounded through the resistor R7 and also connected to the control circuit 20 through the resistor R6. The drain of the FET Q3 is connected to the chargeable battery 200 through the resistor R9. The resistor R10 is connected to the resistor R9 in parallel. Two ends of the resistor R9 are connected to the control circuit 20. The capacitor C3 is connected between the drain of the FET Q3 and ground.

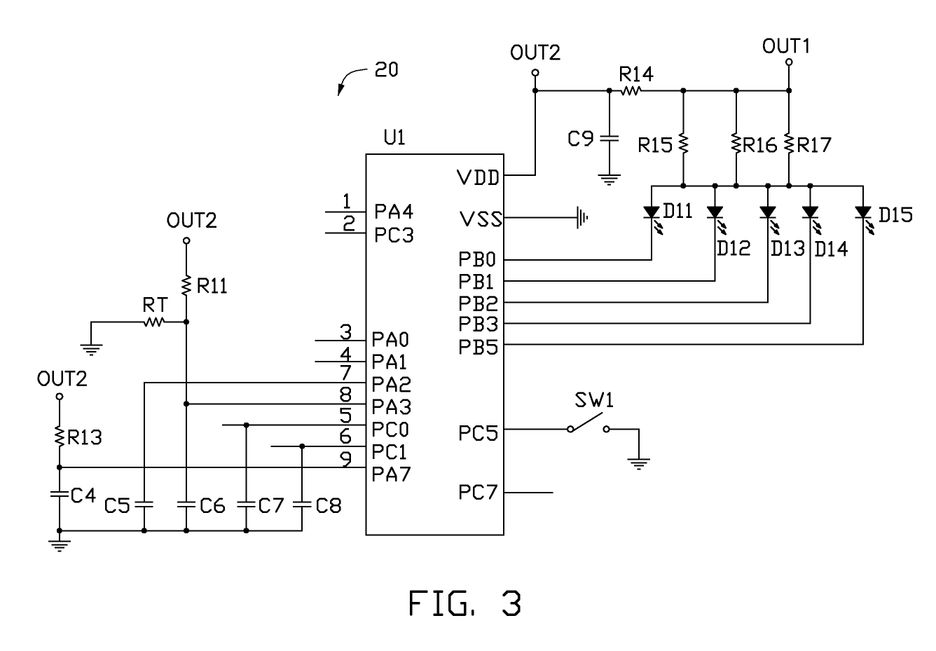

Referring to FIG. 3, the control circuit 20 includes a microprocessor U1, a thermistor RT, a switch SW1, capacitors C4-C9, resistors R11-R17, and light emitting diodes (LEDs) D11-D15. An input output (I/O) pin PA4 of the microprocessor U1 is connected to the base of the transistor Q4 through the resistor R6. I/O pins PC3 and PA0 of the microprocessor U1 are connected to the discharging circuit 30. An I/O pin PA1 of the microprocessor U1 is connected to an output terminal of the adapter 100. I/O pins PC0 and PC1 are respectively connected to the two ends of the resistor R9. I/O pins PA2, PA3, PC0, PC1, and PA7 of the microprocessor U1 are grounded through the capacitors C5-C8 and C4, respectively. The I/O pin PA7 of the microprocessor U1 is connected to the discharging circuit 30 through the resistor R13. The I/O pin PA3 of the microprocessor U1 is connected to the discharging circuit 30 through the resistor R11 and also grounded through the thermistor RT. A voltage pin VDD of the microprocessor U1 is connected to the discharging circuit 30 and also connected to anodes of the LEDs D11-D15 through the resistors R14-R17. A node between the resistors R14 and R17 is connected to the discharging circuit 20. The resistors R15 and R16 are connected to the resistor R17 in parallel. The capacitor C9 is connected between the voltage pin VDD of the microprocessor U1 and ground. Cathodes of the LEDs D11-D15 are respectively connected to I/O pins PB0-PB3 and PBS. An I/O pin PC5 of the microprocessor U1 is grounded through the switch SW1. An I/O pin PC7 of the microprocessor U1 is connected to the discharging circuit 30. In one embodiment, the thermistor RT is a negative temperature coefficient thermistor. In one embodiment, the LEDs D11-D14 are used for indicating the remaining power of the chargeable battery 200, such as 20%, 40%, 60%, or 80%. The LED D15 is used for indicating that the chargeable battery 200 is discharging.

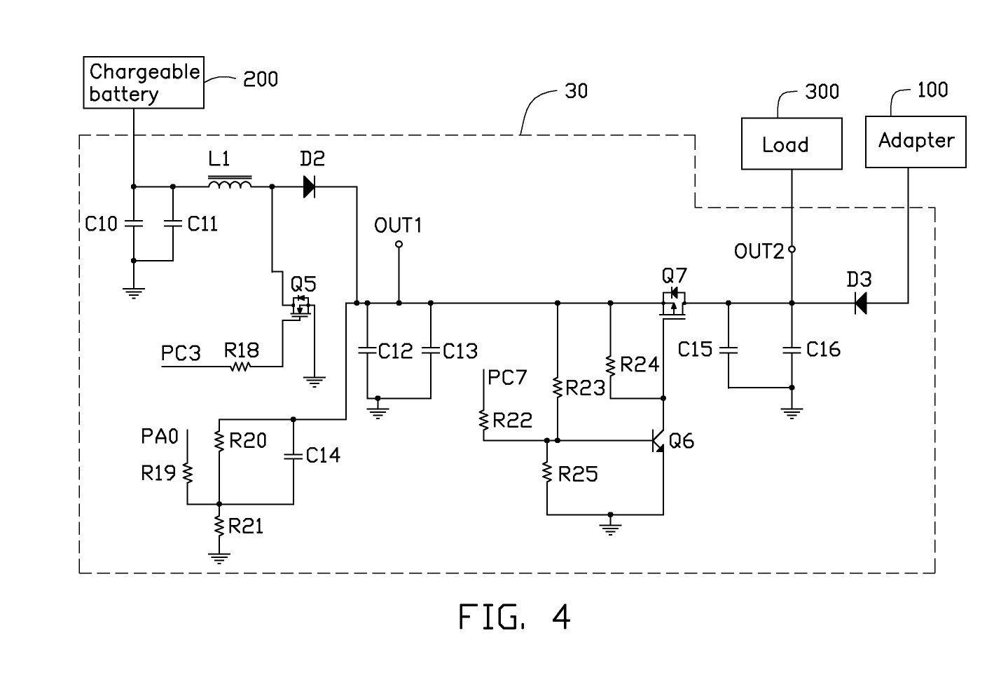

Referring to FIG. 4, the discharging circuit 30 includes an inductor L1, capacitors C10-C16, resistors R18-R25, diodes D2 and D3, a transistor Q6, FETs Q5 and Q7, and output terminals OUT1 and OUT2. A gate of the FET Q5 is connected to the I/O pin PC3 of the microprocessor U1 though the resistor R18. A source of the FET Q5 is grounded. A drain of the FET Q5 is connected to the chargeable battery 200 through the inductor L1 and also grounded through the capacitors C10 and C11 connected in parallel. An anode of the diode D2 is connected to the drain of the FET Q5. A cathode of the diode D2 is connected to the output terminal OUT1 and also connected to a source of the FET Q7. The capacitors C12 and C13 are connected between the output terminal OUT1 and ground in parallel. The cathode of the diode D2 is also connected to the I/O pin PA0 of the microprocessor U1 through the resistors R20 and R19 connected in series. The capacitor C14 is connected to the resistor R20 in parallel. The resistor R21 is connected between a node of the resistors R20 and R19 and ground. A gate of the FET Q7 is connected to a collector of the transistor Q6. The resistor R24 is connected between the source of the FET Q7 and the gate of the FET Q7. An emitter of the transistor Q6 is grounded. A base of the transistor Q6 is connected to the source of the FET Q7 through the resistor R23 and also connected to the I/O pin PC7 through the resistor R22. The resistor R25 is connected between the base of the transistor Q6 and ground. The drain of the FET Q7 is connected to the load 300 through the output terminal OUT2 and also connected to a cathode of the diode D3. An anode of the diode D3 is connected to the adapter 100. The capacitors C15 and C16 are connected between the drain of the FET Q7 and ground in parallel.

In use, the microprocessor U1 operates when the switch SW1 is closed. When the adapter 100 operates normally, the I/O pin PC7 of the microprocessor U1 outputs a low level signal. The transistor Q6 is turned off. The I/O pin PC3 of the microprocessor U1 outputs a high level signal. The transistor Q5 is turned on. The chargeable battery 200 charges the inductor L1. The transistor Q7 is turned off. The adapter 100 provides a voltage to the load 300 through the diode D3 and the output terminal OUT2. The I/O pin PC1 of the microprocessor U1 measures the voltage of the chargeable battery 200. The I/O pins PA1 and PA4 of the microprocessor U1 output high level signals when the voltage of the chargeable battery 200 is less than the preset value. The transistors Q2 and Q4 are turned on. The collectors of the transistors Q2 and Q4 output low level signals. The FETs Q1 and Q3 are turned on. The adapter 100 charges the chargeable battery 200. The I/O pins PC0 and PC1 of the microprocessor U1 measures the charging current and regulates the charging current through changing duty cycle of a pulse width modulation (PWM) signal of the I/O pin PA4 of the microprocessor U1. The microprocessor U1 measures a temperature of the chargeable battery 200 though the thermistor RT. If the temperature of the chargeable battery 200 becomes greater than a preset temperature, the microprocessor U1 regulates the duty cycle of the PWM signal of the I/O pin PA4 to reduce the temperature of the chargeable battery 200.

When the adapter 100 is powered off, the I/O pin PA1 of the microprocessor U1 does not sense a voltage from the adapter 100, the I/O pin PC3 of the microprocessor U1 outputs a low level signal. The FET Q5 is turned off. The I/O pin PC7 of the microprocessor U1 outputs a high level signal. The transistor Q6 is turned on. The collector of the transistor Q6 outputs a low level signal. The FET Q7 is turned on. The inductor L1 discharges through the output terminal OUT2 and provides a voltage to the load 300. The LEDs D11-D15 receive voltages through the output terminal OUT1 to turn on for indicating that the chargeable battery 200 is discharging and indicating the remaining power of the chargeable battery 200. The I/O pin PA0 of the microprocessor U1 measures a discharging voltage of the inductor L1 for determining whether the output voltage of the inductor L1 satisfies a requirement of the load 300.

The power supply circuit 500 provides a voltage to the load 300 and charges the chargeable battery 300 when the adapter 100 operates normally, and regulates a charging current according to the charging current and the temperature of the chargeable battery 200 to prevent damage to the chargeable battery 200. The power supply circuit 500 can also control the chargeable battery 200 to discharge to provide a voltage to the load 300 when the adapter 100 is powered off, to prevent the storage device 1 from losing data.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power supply circuit, comprising:
a chargeable battery;
a discharging circuit;
a load;
an adapter connected to a power source, to receive a first voltage from the power source and convert the first voltage to a second voltage;
a charging circuit to receive the second voltage from the adapter and charge the chargeable battery; and
a control circuit to receive the second voltage from the adapter and control the charging circuit to charge the chargeable battery or control the chargeable battery to discharge through the discharging circuit;
wherein when the adapter operates normally, the control circuit measures a voltage of the chargeable battery, and controls the charging circuit to charge the chargeable battery when the voltage of the chargeable battery is less than a preset value, the control circuit measures a charging current and a temperature of the chargeable battery, and regulates the charging current through the charging circuit according to the measured charging current and temperature, the adapter provides a voltage to the load through the discharging circuit; when the adapter is powered off, the control circuit does not sense a voltage from the adapter, the control circuit controls the chargeable battery to power the load through the discharging circuit.

2. The power supply circuit of claim 1, wherein the charging circuit comprises first to tenth resistors, first to third capacitors, first and second bipolar junction transistors, first and second field effect transistors (FETs), and a first diode, the adapter is connected to a drain of the first FET and also grounded through the first capacitor, the drain of the first FET is also connected to an anode of the first diode and the control circuit, and also grounded through the second resistor, a gate of the first FET is connected to a collector of the first transistor, an emitter of the first transistor is grounded, a base of the first transistor is grounded through the third resistor and also connected to the drain of the first FET through the first resistor, the fourth resistor is connected between the source of the first FET and the gate of the first FET, a cathode of the first diode is connected to the drain of the first FET, a gate of the second FET is connected to the collector of the second transistor through the eighth resistor and also connected to the source of the first FET through the fifth resistor, the source of the first FET is also connected to a source of the second FET and also connected to a gate of the second FET through the second capacitor, an emitter of the second transistor is grounded, a base of the second transistor is grounded through the seventh resistor and also connected to the control circuit through the sixth resistor, a drain of the second FET is connected to the chargeable battery through the ninth resistor, the tenth and ninth resistors are connected in parallel, the ends of the ninth resistor are connected to the control circuit, the third capacitor is connected between the drain of the second FET and ground.

3. The power supply circuit of claim 2, wherein the control circuit comprises a microprocessor, a switch, fourth to eighth capacitors, and an eleventh resistor, a first input output (I/O) pin of the microprocessor is connected to the base of the second transistor through the sixth resistor, second and third I/O pins of the microprocessor are connected to the charging circuit, a fourth I/O pin of the microprocessor is connected to the adapter, fifth and sixth I/O pins of the microprocessor are respectively connected to two ends of the ninth resistor, seventh I/O pin, eighth I/O pin, fifth I/O pin, sixth I/O pin, and ninth I/O pin of the microprocessor are grounded through the fifth to eight capacitors and the fourth capacitor, respectively, the ninth I/O pin of the microprocessor is also connected to the discharging circuit through the eleventh resistor, a voltage pin of the microprocessor is connected to the control circuit, the tenth I/O pin of the microprocessor is grounded through the switch, an eleventh I/O pin of the microprocessor is connected to the discharging circuit.

4. The power supply circuit of claim 3, wherein the control circuit further comprises a twelfth resistor and a thermistor, the thermistor is a negative temperature coefficient thermistor, the eighth I/O pin of the microprocessor is connected to the discharging circuit through the twelfth resistor and also grounded through the thermistor.

5. The power supply circuit of claim 4, wherein the control circuit further comprises first to fifth light emitting diodes (LEDs), thirteenth to sixteenth resistors, and a ninth capacitor, the voltage pin of the microprocessor is connected to anodes of the first to fifth LEDs through the thirteenth and fourteenth resistors in series, the control circuit is connected to a node between the thirteenth and fourteenth resistors, the fourteenth to sixteenth resistors are connected in parallel, the ninth capacitor is connected between the voltage pin of the microprocessor and ground, cathodes of the first to fifth LEDs are connected to twelfth to sixteen I/O pins of the microprocessor, respectively.

6. The power supply circuit of claim 5, wherein the discharging circuit comprises an inductor, tenth to sixteenth capacitors, eighteenth to twenty-fifth resistors, second and third diodes, a third transistor, third and fourth FETs, and first and second output terminals, a gate of the third FET is connected to the second I/O pin of the microprocessor through the eighteenth resistor, a source of the third FET is grounded, a drain of the third FET is connected to the chargeable battery through the inductor and also grounded through the tenth capacitor, the eleventh and tenth capacitors are connected in parallel, an anode of the second diode is connected to the drain of the third FET, a cathode of the second diode is connected to the first output terminal and a source of the fourth FET, the twelfth and thirteenth capacitors are connected between the first output terminal and ground in parallel, a cathode of the second diode is connected to the third I/O pin of the microprocessor through the twentieth and nineteenth resistors, the fourteenth capacitor and the twentieth resistor are connected in parallel, the twenty-first resistor is connected to a node between the twentieth and ninth resistors and ground, a gate of the fourth FET is connected to the collector of the third transistor, the twenty-fourth resistor is connected between the source of the fourth FET and the gate of the fourth FET, an emitter of the third transistor is grounded, a base of the third transistor is connected to the source of the fourth FET through the twenty-third resistor also connected to the ninth I/O pin of the microprocessor through the twenty-second resistor, the twenty-fifth resistor is connected between the base of the third transistor and ground, a drain of the fourth FET is connected to the load through the second output terminal and also connected to a cathode of the third diode, an anode of the third diode is connected to the adapter, the fifteenth and sixteenth capacitors are connected between the drain of the fourth FET and ground in parallel.
